(19) United States
(12) Patent Application Publication
(10) Pub. No.: US 2010/0269053 A1
(43) Pub. Date: Oct. 21, 2010

(54) METHOD FOR SECURITY AND MARKET SURVEILLANCE OF A VIRTUAL WORLD ASSET THROUGH INTERACTIONS WITH A REAL WORLD MONITORING CENTER

(75) Inventors: Charles S. Lingafelt, Durham, NC (US); Michael J. Martine, Chapel Hill, NC (US); Michael Rowe, Durham, NC (US)

Correspondence Address: CAHN & SAMUELS, LLP, 1100 17th STREET, NW, SUITE 401, WASHINGTON, DC, 20036, US

(73) Assignee: International Business Machines, Armonk, NY (US)

(21) Appl. No.: 12/424,113

(22) Filed: Apr. 15, 2009

(51) Int. Cl. G06F 3/048; G06F 15/173; G06F 12/14

(52) U.S. Cl. 715/757; 709/224; 726/23; 709/224

(57) ABSTRACT

An embodiment of the invention provides a method for security and market surveillance of a virtual world asset through interactions with a real world monitoring center. The method monitors at least one virtual world object in a virtual world, including detecting at least one virtual world event associated with the virtual world object. A notification of the virtual world event is received by a real world operations center. In response to the receiving of the notification, the real world operations center automatically sends the real world response to an end user and/or the virtual world response to the virtual world. The real world response includes a telephone call, a text message, an email, an audible alert, and/or a silent alert.

### I. FIELD OF THE INVENTION

The present invention is in the field of systems, methods, and computer program products for security and market surveillance of a virtual world asset through interactions with a real world monitoring center.

### II. BACKGROUND OF THE INVENTION

Virtual worlds are becoming increasingly larger and complex, representing billions of dollars in service revenues. This is enabled by continually declining CPU and network interconnection costs and advances in virtual world systems.

A virtual world is a computer-based simulated environment intended for its users to inhabit and interact via avatars. These avatars are usually depicted as textual, two-dimensional, or three-dimensional graphical representations, although other forms are possible (auditory and touch sensations for example). Some, but not all, virtual worlds allow for multiple users.

### III. SUMMARY OF THE INVENTION

At least one embodiment of the invention provides a method for security and market surveillance of a virtual world asset through interactions with a real world monitoring center. The method monitors at least one virtual world object in a virtual world, including detecting at least one virtual world event associated with the virtual world object. A notification of the virtual world event is received by a real world operations center. The notification includes attribute information of the virtual world object (e.g., identity, location, orientation, active/inactive status, and/or open/close status) and the correlation value between the virtual world object and the virtual world event.

The real world operations center determines a real world response and/or a virtual world response based on the correlation value. In response to the receiving of the notification, the real world operations center automatically sends the real world response to an end user and/or the virtual world response to the virtual world. The real world response includes a telephone call, a text message, an email, an audible alert, and/or a silent alert.

In an embodiment of the invention, the detecting of the virtual world event detects malicious software. In another embodiment, the detecting of the virtual world event detects the most visited virtual stores of a plurality of virtual stores and/or the virtual stores having the highest sales volumes. In still another embodiment, the detecting of the virtual world event detects: the most visited areas within a single store of the plurality of virtual stores, the number of times an avatar of a plurality of avatars visits the virtual store, the number of times the virtual store has been visited by the plurality of avatars, patterns of visits to the virtual store based on time of day, and/or patterns of visits to the virtual store based on day of week.

In yet another embodiment, the detecting of the virtual world event detects an interaction between the virtual world object and at least one third party. The third party is an avatar and/or an autonomous object. The virtual world response includes: identifying the third party, obtaining an image of the third party, activating a virtual world security system (an alarm and/or security avatars), reporting the virtual world event to a central authority in the virtual world, closing down the virtual world object, including preventing interaction between the virtual world object and the third party and interaction between the virtual world object and additional third parties, and/or freezing assets owned by the third party.

At least one embodiment of the invention provides a system for security and market surveillance of a virtual world asset through interactions with a real world monitoring center. The system has a monitor and a real world operations center. The monitor is adapted to monitor at least one virtual world object in a virtual world and detect at least one virtual world event associated with the virtual world object.

In at least one embodiment, the virtual world event is the presence of malicious software. In another embodiment, the virtual world event is the most visited virtual stores and/or the virtual stores having the highest sales volumes. In still another embodiment, the virtual world event is the most visited areas within a single store, the number of times an avatar visits the virtual store, the number of times the virtual store has been visited by the avatars, patterns of visits to the virtual store based on time of day, and/or patterns of visits to the virtual store based on day of week.

In yet another embodiment, the virtual world event is an interaction between the virtual world object and at least one third party. The third party is an avatar and/or an autonomous object. The virtual world response includes: identifying the third party, obtaining an image of the third party, activating a virtual world security system (e.g., an alarm and/or security avatars), reporting the virtual world event to a central authority in the virtual world, closing down the virtual world object, including preventing interaction between the virtual world object and the third party and interaction between the virtual world object and additional third parties, and freezing assets owned by the third party.

The real world operations center receives a notification of the virtual world event. The notification includes attribute information of the virtual world object (e.g., identity, location, orientation, active/inactive status, and/or open/close status) and/or a correlation value between the virtual world object and the virtual world event. The real world operations center determines a real world response and/or a virtual world response based on the correlation value. In response to the notification, the real world operations center automatically sends the real world response to an end user and/or the virtual world response to the virtual world. The real world response is a telephone call, a text message, an email, an audible alert, and/or a silent alert.

### IV. BRIEF DESCRIPTION OF THE DRAWINGS

The present invention is described with reference to the accompanying drawings. In the drawings, like reference numbers indicate identical or functionally similar elements.

FIG. 1 is a schematic diagram illustrating virtual world and real world relationships according to an embodiment of the invention;

FIG. 2 is a schematic diagram illustrating preparation for a virtual world to real world activity notification according to an embodiment of the invention;

FIG. 3 is a schematic diagram illustrating an operations phase for each virtual world object under surveillance according to an embodiment of the invention;

FIG. 4 is a flow diagram illustrating a method for security and market surveillance of a virtual world asset through interactions with a real world monitoring center according to an embodiment of the invention;

FIG. 5 is a schematic diagram illustrating a system for security and market surveillance of a virtual world asset through interactions with a real world monitoring center according to an embodiment of the invention; and

FIG. 6 illustrates a computer program product according to an embodiment of the invention.

### V. DETAILED DESCRIPTION OF THE DRAWINGS

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

The concept of monitoring assets as a service in the real world is applied to virtual world assets. An embodiment of the invention monitors virtual world assets (also referred to herein as “virtual world objects”) with real world techniques. More specifically, an embodiment of the invention associates a virtual world asset with a message to a real world (security) operations center. When the virtual world asset is interacted, the real world operations center is informed. The real world operations center carries out the requested services, potentially including additional interactions with the virtual world.

In applications in which a virtual world is created and humans project themselves into the world in the form of an “actor” which can interact within the virtual world, at least one embodiment of the invention provides services which support the interaction between the virtual world and the real world. Examples of virtual worlds include: SECOND LIFE, 3DVIRTUAL, METAVERSE, and massively multiplayer online role-playing games (MMORPGs). The term avatar is generally used to describe an “actor” in the virtual world.

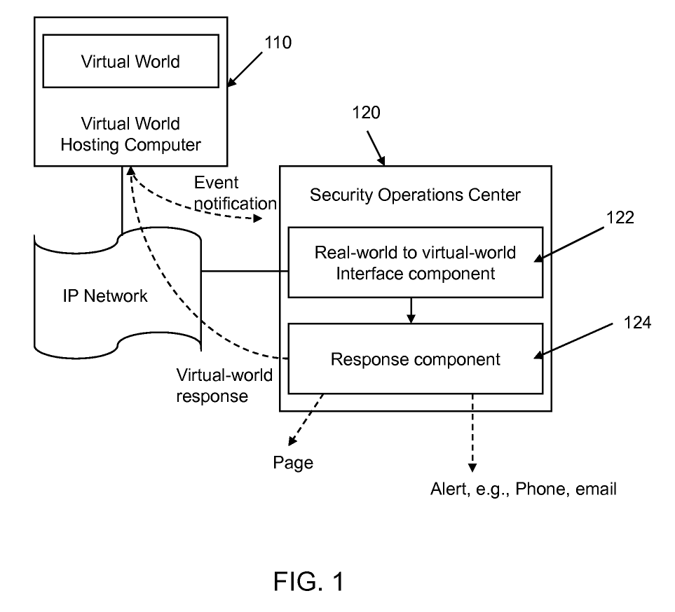

A service provides surveillance of a virtual world asset and the transmission of this information to a real world monitoring center. In at least one embodiment, the real world monitoring center is in the form of a security operations center (SOC) which follows predefined process(es) instigated by an activity associated with the virtual world asset, e.g., an avatar approaching a location or interacting with an asset or other avatar. As illustrated in FIG. 1, a virtual world event notification is sent from a virtual world hosting computer 110 to the SOC 120. A real world to virtual world interface component 122 within the SOC 120 receives the event notification; and, a response component 124 within the SOC 120 performs the pre-defined actions. Examples of pre-defined actions include paging a person and/or sending an email. The response can also be a virtual world response which is sent back to the virtual world for execution.

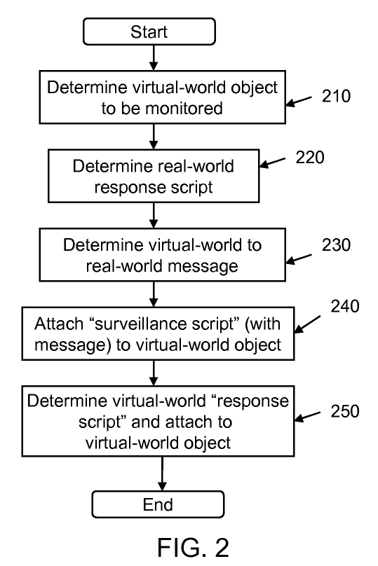

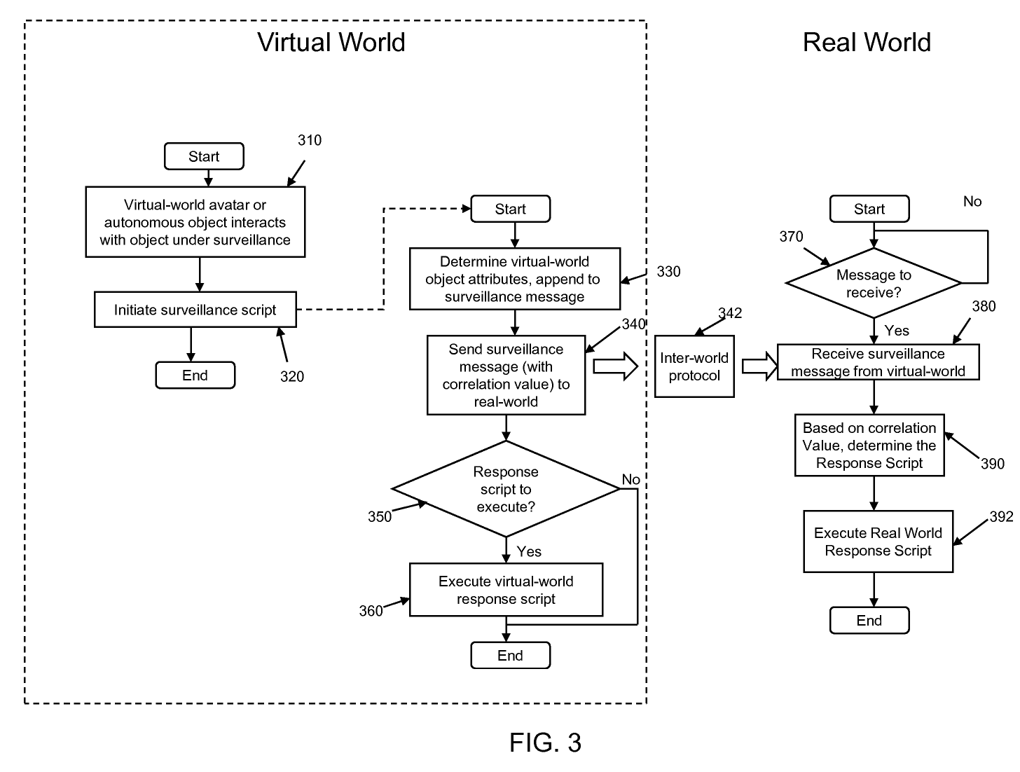

In an embodiment of the invention, the service is illustrated in FIG. 2, which gives the method steps for preparing the components of the service, and FIG. 3, which gives the method steps for operation of service. At least one embodiment herein ties a virtual world asset to a real world “representation” of the asset coupled with a service action.

Just as in the real world, objects in the virtual world will have value. A system is provided which observes the valuable object and if interacted with, invokes a response. An embodiment of the invention links virtual world actions against a virtual world asset to a real world response service. In FIG. 2, to prepare for operation of the service, the object to be observed is identified (item 210), the real world response is determined (item 220), and the virtual world to real world message is determined (item 230). A script (“surveillance script”) is written which is involved when the virtual world object is interacted with. The source of the interaction is not specific; it can be an avatar or an autonomous object. The surveillance script contains the message which is sent to the real world's (security) operations center. In at least one embodiment, the content of this message includes attribute information about the object under surveillance, such as its identity, its current location and orientation, and its current state (e.g., active, inactive, open, close, state of internal object variable of importance). The message also includes a correlation value which the real world operations center uses to determine the correct real world response script to invoke. The “surveillance script” is attached to the virtual world object (item 240).

The real world response script is the set of steps performed by the operations center in response to a surveillance event. Additionally, an optional virtual world response script may be attached to the virtual world object, to be executed by the virtual world system (item 250).

As illustrated in FIG. 3, the service is placed in operation. The inter-world message protocol can be a really simple syndication (RSS) feed, extensible markup language (XML) remote procedure call (RPC), transmission control protocol (TCP) and user datagram protocol (UDP) messages, or an interface provided by the virtual world provider of service.

During operation of the service, the object under surveillance is interacted with by an avatar or some other entity, such as an autonomous object (item 310). This causes the invocation of the virtual world response script (item 320). The virtual world object attributes are determined and appended to the surveillance message (item 330); and, the surveillance message is sent (with the correlation value) to the real world (item 340) using an inter-world protocol 342.

The real world operations center receives the information, using the correlation value, determines which monitored virtual world asset has been interacted with, and based on rules, determines the appropriate response script and executes that script. Within the virtual world, if a virtual world response script was prepared (item 350), it is executed (item 360).

If there is a message from the virtual world (item 370), the message is received (item 380). Based on the correlation value, the response script is determined (item 390) and executed (item 392). The result of these real world service method steps is a security action, such as an alert sent to a designated person, a protective action, such as the execution of a script within the virtual world or some other predefined action.

In at least one embodiment, the real world response is in the form of a customer response center which follows predefined process(es) instigated by an activity associated with the virtual world asset, such as, for example, an avatar entering a location or interacting with another object or other avatar. This service is illustrated in FIG. 3. The results of these service method steps may also be an informational action, such as used for marketing information or customer behavior information. For example, one could establish a service that counted the number of times an avatar visited a virtual store(s) or the pattern of visits correlated with time of day or day of week. Another example is the within a virtual store, identifying the most popular areas of the virtual store. Another example is a service in which a distributor of a product via multiple virtual stores counts the number of visitors or the number of sales to determine the most visited store or the store with the highest sales of the product.

In virtual worlds, avatars have a unique identifier for the purpose of logging on. This can be the unique identifying number (such as in the ActiveWorlds platform) or a unique logon name which is used to identify the avatar and correlate it to an action in the virtual world. The optional virtual world response can include, for example, capturing the avatar's unique identifier, taking a virtual picture of the offender, flashing strobe lights, summoning security avatars or bots, reporting the event to the central authority of the virtual world, locking the account to prevent further log-ins, and/or freezing the inventory of the offending avatar.

In an exemplary embodiment of the invention, security is set in a virtual world museum to prevent anyone from taking a virtual world DaVinci Mona Lisa portrait, as well as to track anyone that attempts to perform an action on the portrait, such as copying it, moving it, or attempting to vandalize it. Responses to these virtual world actions cause a real world notification and an optional virtual world response.

In at least one other embodiment, virus and other malware (malicious software) are introduced into the virtual world. Thus, methods herein are extended to apply to a virus detection and response system. In such methods, the virtual world surveillance script is replaced with a virtual world malware detection agent, similar in function to a real world virus detection agent, except that the virtual world agent operates at the application layer, observing malicious behavior. This observation can be based on signatures, heuristics, and/or observation of abnormal behavior. The virtual world malware agent would then communication, per the methods described above, to a real world virus monitoring service. The service would perform service functions, such as correlation of malware events, reporting of malware events, and responding to malware events. Accordingly, an embodiment of the invention provides a service method for virtual world events into the real world.

As described in further detail below, examples of how a surveillance script detects abnormal events are provided. These scripts may also be used simultaneously and additional scripts of similar structure and/or content may be defined. The format of the illustrative examples is: if <conditional which is used to determine an abnormal event is true> then <notify the real world operations center> (via the steps as illustrated in FIG. 3 and accompanying textual description). The provider of this service is the virtual world provider or proxy. As such, the virtual world provider has access to data with respect to the local environment that the security monitoring is taking place. These surveillance script methods interpret this environmental data into information, and from that information draw a conclusion resulting in a notification to the real world.

In the first example, the detection of the abnormal event involves detecting the number/density of avatars. Periodically the virtual world provider counts and records the number of avatars within the monitored zone. In addition, the virtual world provider quantizes the space between the avatars and determines the spatial distribution of avatars with respect to each other and/or with respect to the monitored zone. This information is periodically recorded. Over a specific time period set by the operator of the service, such as weekdays, weekends, lunch time, and all of the time, the service provider establishes a historical distribution which reflects a typical avatar population number and/or density within the monitored space.

If the virtual world provider of service observes that the current avatar population or density exceeds the historical typical avatar population and/or density by some threshold amount (set by agreement between the customer and the virtual world provider of service), then an abnormal event is detected and the method steps in FIG. 3 are followed, resulting in notification to a real world operations center.

In a second example, the detection of an abnormal event involves detecting the presence of an avatar with a pre-identified public credential. The virtual world provider of service obtains, from the customer, a list of the public credentials used to identify avatars “of interest”, e.g., the media, a specific competitor's name, or other important person (e.g., chairman of the board). The virtual world's provider of service observes all avatars as they enter this monitored space. If an avatar's public credential is found to match the list provided by the customer, then the virtual world provider of service has detected an abnormal event and the method steps in FIG. 3 are followed, resulting in notification to a real world operations center.

In a third example, the presence of an avatar having identity associated in an “exclude list” is detected. Within virtual worlds, certain individuals can be identified over time as problematic or instigators of trouble. These individuals can be identified through crowd sourcing of their behavior patterns. There are multiple methods to identify “instigators of trouble”, ranging from collection of identities by a company function (e.g., a complaint line), to publicly available sources (e.g., the Federal Convicted Sexual Offender list). In some cases the “exclude list” is maintained through a central repository which can be contributed to by other owners in the region, or through a rating system (similar to Amazon™ or e-Bay's™ reputation system). Avatars, as identified by object type, that exist on the exclude list trigger an event message when they come within a customer predefined range of a monitoring device (object) or when they arrive on a virtual parcel (region) as defined within the given virtual world platform. This event may be captured and sent to a control center for action. This is accomplished by the virtual world's provider of service observing all avatars as they enter this monitored space, or within a defined range; and, if the object type value is contained on the exclude list, then the virtual world provider of service has detected an abnormal event. The method steps in FIG. 3 are followed, resulting in notification to a real world operations center.

In addition, the service provider of the virtual world space, in the provision of this service to multiple customers, may populate a common “object exclude list” from interaction with multiple different customers, each contributing to the common list. As an additional service (e.g., for an additional fee), the provider of service may make this common list available to a specific customer.

In a fourth example, the presence of an avatar with an offensive sign or message is detected. During a strike at a virtual world location, one of the techniques for drawing attention to the message that is being sent to those who attend is to carry signs with messages on them. In order to identify such “signs”, the provider of service examines each object attached to an avatar for one or more attributes. If the object contains a threshold number of attributes, as determined by the customer of the service, then the virtual world provider of service has detected an abnormal event. The method steps in FIG. 3 are followed, resulting in notification to a real world operations center.

Examples of attributes that the customer of the service may choose, which are used to determine an instance of an abnormal event, include: object(s) attached to an avatar which are as large as or larger than the avatar itself, object(s) attached to an avatar which contains text, object(s) attached to an avatar which contains certain shapes and/or textures, and object(s) attached to an avatar which have excessive message generation through scripts or animations (“excessive” is defined by the service provider and/or customer).

In a fifth example, the system detects behavior associated with a “no shopping and a large amount of chat & voice-over-Internet protocol (VoIP)”. Many of the “areas” within virtual worlds have a purpose beyond serving as a gathering point. Shopping, presenting, and creating are all examples of purposes why people will congregate in a particular virtual zone. When a significant number of people gather in close proximity and do not take advantage of the purpose of the place (e.g., by clicking on objects and/or showing a presentation), but rather are chatting with one another via text or VoIP, this could be a flag that something out of the ordinary is occurring, that would raise a trigger to warrant an action or response. Thus, the provider of service obtains from the customer the set of actions that are “normally expected” in a zone, a threshold of the number of avatars, and a threshold on the amount of chat & VoIP activity that is considered abnormal. If the virtual world provider of service observes that the number of avatars within in a zone exceeds the threshold and/or the number of actions is less than the “normally expected” number, then the virtual world provider of service has detected an abnormal event. The method steps in FIG. 3 are followed, resulting in notification to a real world operations center.

In a sixth example, known customers versus non-customers are detected. Just like websites, many virtual world places keep track of the frequent visitors, either by noticing/recording their arrival and departure, or through a more formal sign-up process where more information and preferences are disclosed. When a significant number of first time visitors materialize on a site within a short time period, this is a trigger for a response. Thus the provider of service or the customer records in a “prior visit list”, each avatar's object identifier when the avatar enters the area the first time. If the virtual world provider of service or customer observes the arrival of an avatar and the avatar's object identifier is not on the “prior visit list”, then the virtual world provider of service has detected an abnormal event. The method steps in FIG. 3 are followed, resulting in notification to a real world operations center.

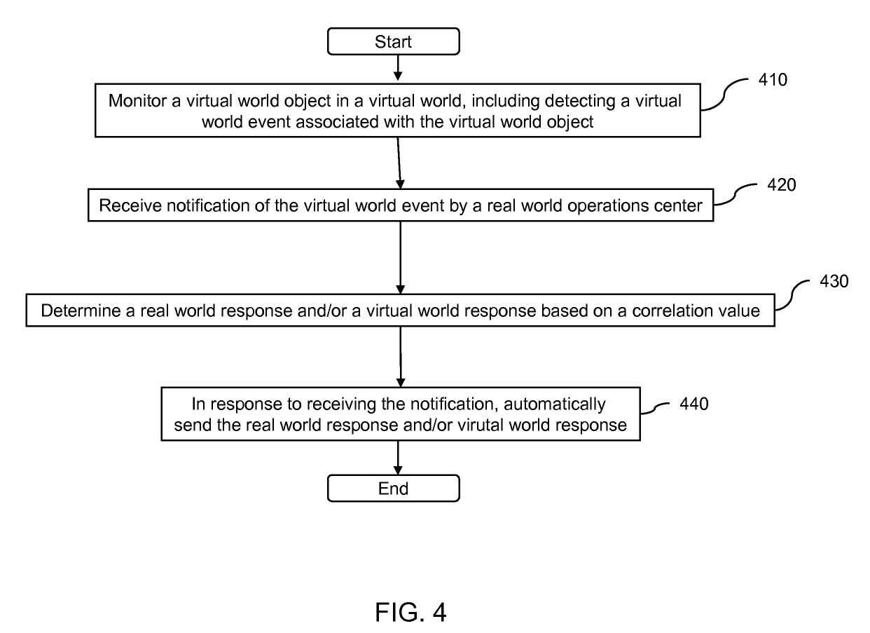

FIG. 4 is a flow diagram illustrating a method for security and market surveillance of a virtual world asset through interactions with a real world monitoring center according to an embodiment of the invention. The method monitors at least one virtual world object in a virtual world, including detecting at least one virtual world event associated with the virtual world object (item 410). A notification of the virtual world event is received by a real world operations center (item 420). The notification includes attribute information of the virtual world object (e.g., identity, location, orientation, active/inactive status, and/or open/close status) and the correlation value between the virtual world object and the virtual world event.

The real world operations center determines a real world response and/or a virtual world response based on the correlation value (item 430). In response to the receiving of the notification, the real world operations center automatically sends the real world response to an end user and/or the virtual world response to the virtual world (item 440). The real world response includes a telephone call, a text message, an email, an audible alert, and/or a silent alert.

In an embodiment of the invention, the detecting of the virtual world event detects malicious software. In another embodiment, the detecting of the virtual world event detects the most visited virtual stores of a plurality of virtual stores and/or the virtual stores having the highest sales volumes. In still another embodiment, the detecting of the virtual world event detects: the most visited areas within a single store of the plurality of virtual stores, the number of times an avatar of a plurality of avatars visits the virtual store, the number of times the virtual store has been visited by the plurality of avatars, patterns of visits to the virtual store based on time of day, and/or patterns of visits to the virtual store based on day of week.

In yet another embodiment, the detecting of the virtual world event detects an interaction between the virtual world object and at least one third party. The third party is an avatar and/or an autonomous object. The virtual world response includes: identifying the third party, obtaining an image of the third party, activating a virtual world security system (an alarm and/or security avatars), reporting the virtual world event to a central authority in the virtual world, closing down the virtual world object, including preventing interaction between the virtual world object and the third party and interaction between the virtual world object and additional third parties, and/or freezing assets owned by the third party.

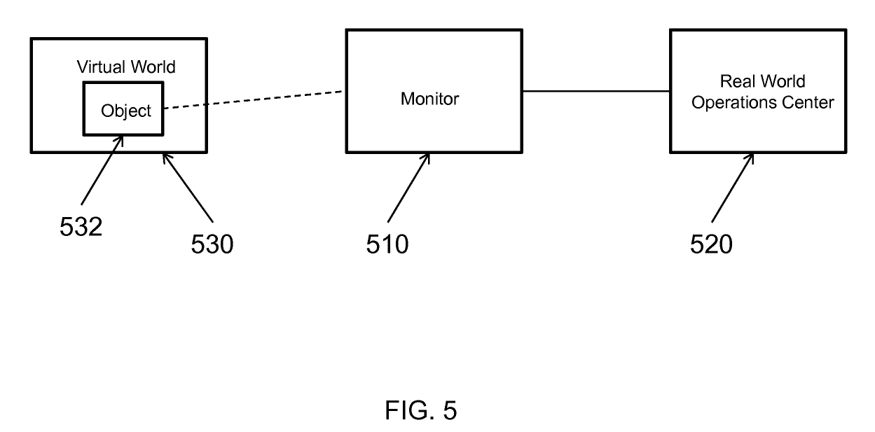

FIG. 5 is a schematic diagram illustrating a system for security and market surveillance of a virtual world asset through interactions with a real world monitoring center according to an embodiment of the invention. The system has a monitor 510 and a real world operations center 520. In an alternative embodiment, the monitor 510 is located within the real world operations center 520. The monitor 510 is adapted to monitor at least one virtual world object 532 in a virtual world 530 and detect at least one virtual world event associated with the virtual world object 532.

In at least one embodiment, the virtual world event is the presence of malicious software. In another embodiment, the virtual world event is the most visited virtual stores and/or the virtual stores having the highest sales volumes. In still another embodiment, the virtual world event is the most visited areas within a single store, the number of times an avatar visits the virtual store, the number of times the virtual store has been visited by the avatars, patterns of visits to the virtual store based on time of day, and/or patterns of visits to the virtual store based on day of week.

In yet another embodiment, the virtual world event is an interaction between the virtual world object 532 and at least one third party. The third party is an avatar and/or an autonomous object. The virtual world response includes: identifying the third party, obtaining an image of the third party, activating a virtual world security system (e.g., an alarm and/or security avatars), reporting the virtual world event to a central authority in the virtual world 530, closing down the virtual world object 532, including preventing interaction between the virtual world object 532 and the third party and interaction between the virtual world object 532 and additional third parties, and freezing assets owned by the third party.

The real world operations center 520 receives a notification of the virtual world event. The notification includes attribute information of the virtual world object 532 (e.g., identity, location, orientation, active/inactive status, and/or open/close status) and/or a correlation value between the virtual world object 532 and the virtual world event. The real world operations center 520 determines a real world response and/or a virtual world response based on the correlation value. In response to the notification, the real world operations center 520 automatically sends the real world response to an end user and/or the virtual world response to the virtual world 530. The real world response is a telephone call, a text message, an email, an audible alert, and/or a silent alert.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

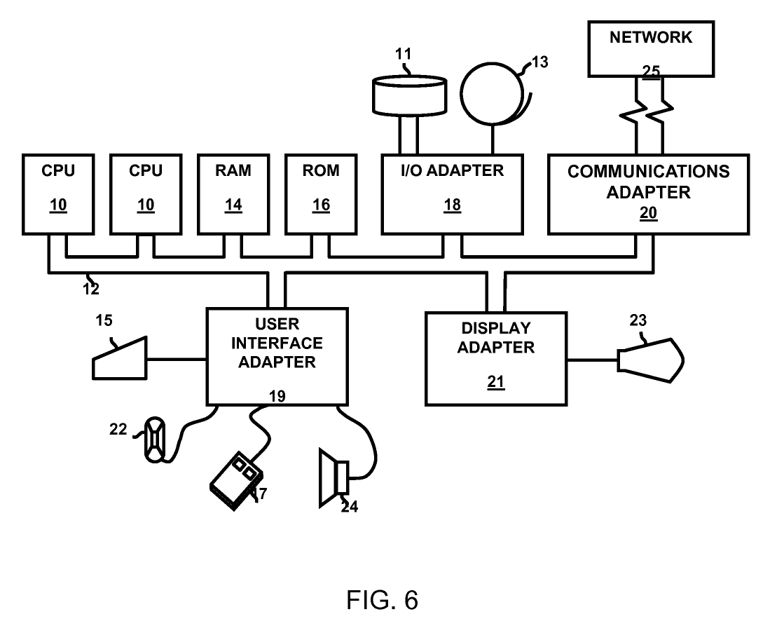

Referring now to FIG. 6, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method, comprising:
monitoring at least one virtual world object in a virtual world, comprising detecting at least one virtual world event associated with said virtual world object;
receiving a notification of said virtual world event by a real world operations center; and
in response to said receiving of said notification, automatically sending, by said real world operations center, at least one of a real world response to an end user and a virtual world response to said virtual world.

2. The method according to claim 1, wherein said detecting of said virtual world event comprises detecting malicious software.

3. The method according to claim 1, wherein said detecting of said virtual world event comprises detecting an interaction between said virtual world object and at least one third party, said third party comprising at least one of an avatar and an autonomous object.

4. The method according to claim 3, wherein said virtual world response comprises at least one of:
identifying said third party;
obtaining an image of said third party;
activating a virtual world security system, said virtual world security system comprising at least one of an alarm and security avatars;
reporting said virtual world event to a central authority in said virtual world;
closing down said virtual world object, comprising preventing interaction between said virtual world object and said third party and interaction between said virtual world object and additional third parties; and
freezing assets owned by said third party.

5. The method according to claim 1, wherein said detecting of said virtual world event comprises detecting at least one of:
the most visited virtual stores of a plurality of virtual stores; and
the virtual stores of said plurality of virtual stores comprising the highest sales volumes.

6. The method according to claim 5, wherein said detecting of said virtual world event comprises detecting at least one of:
the most visited areas within a single store of said plurality of virtual stores;
the number of times an avatar of a plurality of avatars visits said virtual store;
the number of times said virtual store has been visited by said plurality of avatars;
patterns of visits to said virtual store based on time of day; and
patterns of visits to said virtual store based on day of week.

7. The method according to claim 1, wherein said receiving of said notification comprises receiving:
attribute information of said virtual world object, said attribute information comprising at least one of an identity, location, orientation, active/inactive status, and open/close status; and
a correlation value between said virtual world object and said virtual world event.

8. The method according to claim 7, further comprising determining, by said real world operations center, at least one of said real world response and said virtual world response based on said correlation value.

9. The method according to claim 1, wherein said sending of said real world response comprises sending at least one of a telephone call, a text message, an email, an audible alert, and a silent alert.

10. A method, comprising:
monitoring at least one virtual world object in a virtual world, comprising detecting at least one virtual world event associated with said virtual world object;
receiving a notification of said virtual world event by a real world operations center, wherein said receiving of said notification comprises receiving:
attribute information of said virtual world object, said attribute information comprising at least one of an identity, location, orientation, active/inactive status, and open/close status; and
a correlation value between said virtual world object and said virtual world event;
determining, by said real world operations center, at least one of a real world response and a virtual world response based on said correlation value; and
in response to said receiving of said notification, automatically sending, by said real world operations center, at least one of said real world response to an end user and said virtual world response to said virtual world.

11. The method according to claim 10, wherein said detecting of said virtual world event comprises detecting malicious software.

12. The method according to claim 10, wherein said detecting of said virtual world event comprises detecting an interaction between said virtual world object and at least one third party, said third party comprising at least one of an avatar and an autonomous object, and wherein said virtual world response comprises at least one of:
identifying said third party;
obtaining an image of said third party;
activating a virtual world security system, said virtual world security system comprising at least one of an alarm and security avatars;
reporting said virtual world event to a central authority in said virtual world;
closing down said virtual world object, comprising preventing interaction between said virtual world object and said third party and interaction between said virtual world object and additional third parties; and
freezing assets owned by said third party.

13. The method according to claim 10, wherein said detecting of said virtual world event comprises detecting at least one of:
the most visited virtual stores of a plurality of virtual stores;
the virtual stores of said plurality of virtual stores comprising the highest sales volumes;
the most visited areas within a single store of said plurality of virtual stores;
the number of times an avatar of a plurality of avatars visits said virtual store;
the number of times said virtual store has been visited by said plurality of avatars;
patterns of visits to said virtual store based on time of day; and
patterns of visits to said virtual store based on day of week.

14. A system, comprising:
a monitor adapted to monitor at least one virtual world object in a virtual world and detect at least one virtual world event associated with said virtual world object; and
a real world operations center adapted to receive a notification of said virtual world event, and in response to said notification, automatically send at least one of a real world response to an end user and a virtual world response to said virtual world.

15. The system according to claim 14, wherein said virtual world event comprises a presence of malicious software.

16. The system according to claim 14, wherein said virtual world event comprises an interaction between said virtual world object and at least one third party, said third party comprising at least one of an avatar and an autonomous object.

17. The system according to claim 16, wherein said virtual world response comprises at least one of:
identifying said third party;
obtaining an image of said third party;
activating a virtual world security system, said virtual world security system comprising at least one of an alarm and security avatars;
reporting said virtual world event to a central authority in said virtual world;
closing down said virtual world object, comprising preventing interaction between said virtual world object and said third party and interaction between said virtual world object and additional third parties; and
freezing assets owned by said third party.

18. The system according to claim 14, wherein said virtual world event comprises at least one of:
the most visited virtual stores of a plurality of virtual stores; and
the virtual stores of said plurality of virtual stores comprising the highest sales volumes.

19. The system according to claim 18, wherein said virtual world event comprises at least one of:
the most visited areas within a single store of said plurality of virtual stores;
the number of times an avatar of a plurality of avatars visits said virtual store;
the number of times said virtual store has been visited by said plurality of avatars;
patterns of visits to said virtual store based on time of day; and
patterns of visits to said virtual store based on day of week.

20. The system according to claim 14, wherein said notification comprises:
attribute information of said virtual world object, said attribute information comprising at least one of an identity, location, orientation, active/inactive status, and open/close status; and
a correlation value between said virtual world object and said virtual world event.

21. The system according to claim 20, wherein said real world operations center is adapted to determine at least one of said real world response and said virtual world response based on said correlation value.

22. The system according to claim 14, wherein said real world response comprises at least one of a telephone call, a text message, an email, an audible alert, and a silent alert.

23. A computer program product comprising computer readable program code stored on computer readable storage medium embodied therein for performing a method comprising:
monitoring at least one virtual world object in a virtual world, comprising detecting at least one virtual world event associated with said virtual world object;
receiving a notification of said virtual world event by a real world operations center, wherein said receiving of said notification comprises receiving:
attribute information of said virtual world object, said attribute information comprising at least one of an identity, location, orientation, active/inactive status, and open/close status; and
a correlation value between said virtual world object and said virtual world event;
determining, by said real world operations center, at least one of a real world response to an end user and a virtual world response to said virtual world based on said correlation value; and
in response to said receiving of said notification, automatically sending, by said real world operations center, at least one of said real world response and said virtual world response.

24. The computer program product according to claim 23, wherein said detecting of said virtual world event comprises detecting an interaction between said virtual world object and at least one third party, said third party comprising at least one of an avatar and an autonomous object, and wherein said virtual world response comprises at least one of:
identifying said third party;
obtaining an image of said third party;
activating a virtual world security system, said virtual world security system comprising at least one of an alarm and security avatars;
reporting said virtual world event to a central authority in said virtual world;
closing down said virtual world object, comprising preventing interaction between said virtual world object and said third party and interaction between said virtual world object and additional third parties; and
freezing assets owned by said third party.

25. The computer program product according to claim 23, wherein said detecting of said virtual world event comprises detecting at least one of:
the most visited virtual stores of a plurality of virtual stores;
the virtual stores of said plurality of virtual stores comprising the highest sales volumes;
the most visited areas within a single store of said plurality of virtual stores;
the number of times an avatar of a plurality of avatars visits said virtual store;
the number of times said virtual store has been visited by said plurality of avatars;
patterns of visits to said virtual store based on time of day; and
patterns of visits to said virtual store based on day of week.
